(19) United States
(12) Patent Application Publication
(10) Pub. No.: US 2012/0044080 A1
(43) Pub. Date: Feb. 23, 2012

(54) METHOD AND CIRCUIT FOR DETECTING HIGH-VOLTAGE DISCHARGE OF A GAS-ACTUATED FASTENER-DRIVING GUN

(76) Inventor: Yimin Zhu, Chongging (CN)

(21) Appl. No.: 13/081,985

(22) Filed: Apr. 7, 2011

(30) Foreign Application Priority Data
Aug. 20, 2010 (CN) 201010259021.7

(51) Int. Cl. G08B 21/00

(52) U.S. Cl. 340/661; 340/662

(57) ABSTRACT

In a method and circuit for detecting high-voltage discharge of a gas-actuated fastener-driving gun, an attenuating unit attenuates a discharge voltage from the gas-actuated fastener-driving gun to generate a positive pulse signal. A signal processing unit processes the positive pulse signal to generate a processed pulse signal with an amplified amplitude. A determining unit outputs a control signal upon detecting that the processed pulse signal is greater than a predetermined voltage. A warning unit generates, based on the control signal from the determining unit, a warning output for indicating that the high-voltage discharge is abnormal.

### CROSS-REFERENCE TO RELATED APPLICATION

This application claims priority of Chinese Application No. 201010259021.7, filed on Aug. 20, 2010.

### BACKGROUND OF THE INVENTION

1. Field of the Invention

The invention relates to a method and circuit for detecting a gas-actuated fastener-driving gun, and more particularly to a method and circuit for detecting high-voltage discharge of a gas-actuated fastener-driving gun.

2. Description of the Related Art

A gas-actuated fastener-driving gun includes an ignition system. The ignition system includes a power source, an ignition boosting unit consisting of a high voltage coil, a transformer and a capacitor module, a high-voltage transmitting unit consisting of a transmission wiring, a spark plug nut and a spark plug, and a high-voltage discharge unit consisting of a discharge needle and a negative terminal. The ignition boosting unit generates a high voltage. The high voltage is transmitted to the high-voltage discharge unit through the high-voltage transmitting unit. Thus, sparks are generated in response to point discharge from the discharge needle to the negative terminal to ignite gas. As a result, a driving force is generated in response togas combustion to urge a firing pin assembly to thereby drive a fastener into a substrate. When the high-voltage discharge of the gas-actuated fastener-driving gun is normal, a discharge voltage signal, as shown in FIG. 1, generated by the gas-actuated fastener-driving gun has a negative pulse component with a relatively large peak value.

However, after a period of use, lubricant dirt and carbon accumulation on the discharge needle and the negative terminal adversely affects high-voltage discharge of the gas-actuated fastener-driving gun. FIG. 2 illustrates the discharge voltage signal when the high-voltage discharge is abnormal, wherein the discharge voltage signal has negative and positive pulse components with relatively large peak values.

### SUMMARY OF THE INVENTION

Therefore, an object of the present invention is to provide a method and circuit for detecting high-voltage discharge of a gas-actuated fastener-driving gun that are capable of generating a warning output when the high-voltage discharge is abnormal.

According to one aspect of the present invention, there is provided a method of detecting high-voltage discharge of a gas-actuated fastener-driving gun. The method comprises the steps of:

a) obtaining a discharge voltage signal generated by the gas-actuated fastener-driving gun and corresponding to the high-voltage discharge, and attenuating the discharge voltage signal to generate a positive pulse signal;

b) processing the positive pulse signal to generate a processed pulse signal with an amplified amplitude;

c) determining whether the processed pulse signal is greater than a predetermined voltage; and

d) generating a warning output for indicating that the high-voltage discharge is abnormal when the processed pulse signal is greater than the predetermined voltage.

According to another aspect of the present invention, there is provided a circuit for detecting high-voltage discharge of a gas-actuated fastener-driving gun. The gas-actuated fastener-driving gun includes an ignition system that generates a discharge voltage signal corresponding to the high-voltage discharge. The circuit comprises:

an attenuating unit adapted to be coupled to the ignition system for receiving the discharge voltage therefrom and for attenuating the discharge voltage signal to generate a positive pulse signal;

a signal processing unit coupled to the attenuating unit, said signal processing unit receiving and processing the positive pulse signal from the attenuating unit to generate a processed pulse signal with an amplified amplitude;

a determining unit coupled to the signal processing unit, said determining unit receiving the processed pulse signal from the signal processing unit, determining whether the processed pulse signal is greater than a predetermined voltage, and outputting a control signal upon detecting that the processed pulse signal is greater than the predetermined voltage; and

a warning unit coupled to the determining unit, said warning unit receiving the control signal from the determining unit, and generating, based on the control signal, a warning output for indicating that the high-voltage discharge is abnormal.

### BRIEF DESCRIPTION OF THE DRAWINGS

Other features and advantages of the present invention will become apparent in the following detailed description of the preferred embodiment with reference to the accompanying drawings, of which:

FIG. 1 is a waveform of a normal high-voltage discharge signal generated by a gas-actuated fastener-driving gun;

FIG. 2 is a waveform of an abnormal high-voltage discharge signal generated by the gas-actuated fastener-driving gun;

FIG. 3 is a schematic circuit block diagram illustrating the preferred embodiment of a circuit for detecting high-voltage discharge of a gas-actuated fastener-driving gun according to the present invention;

FIG. 4 is a schematic electrical circuit diagram illustrating the preferred embodiment; and

FIG. 5 is a flow chart of a method of detecting high-voltage discharge of a gas-actuated fastener driving gun performed by the preferred embodiment.

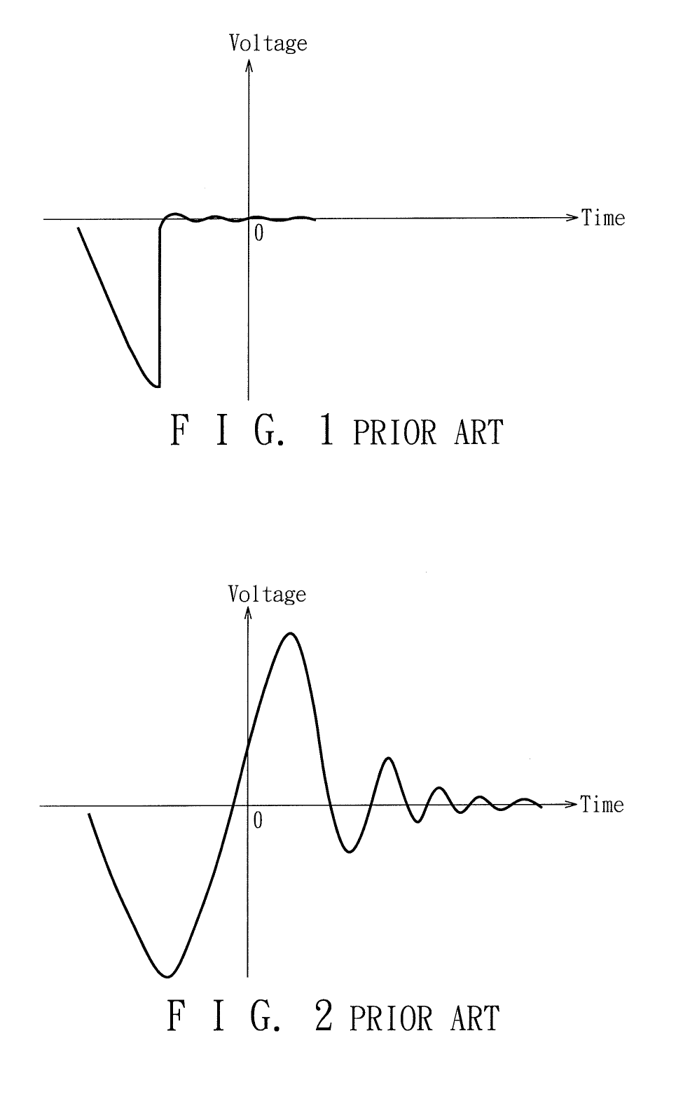

### DETAILED DESCRIPTION OF THE PREFERRED EMBODIMENT

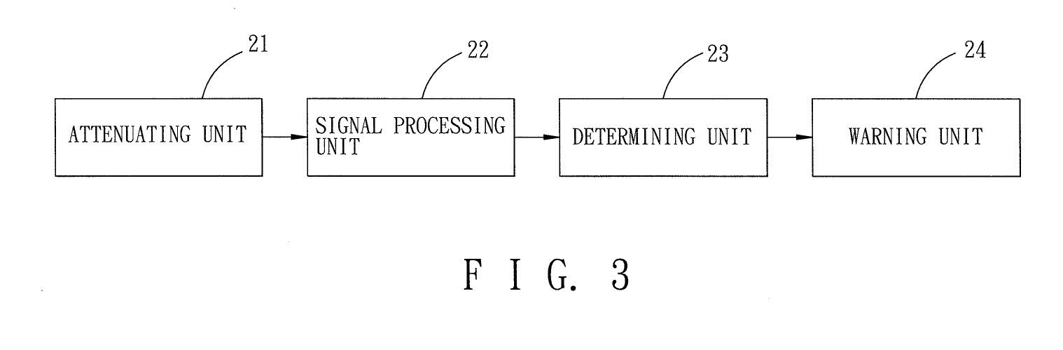

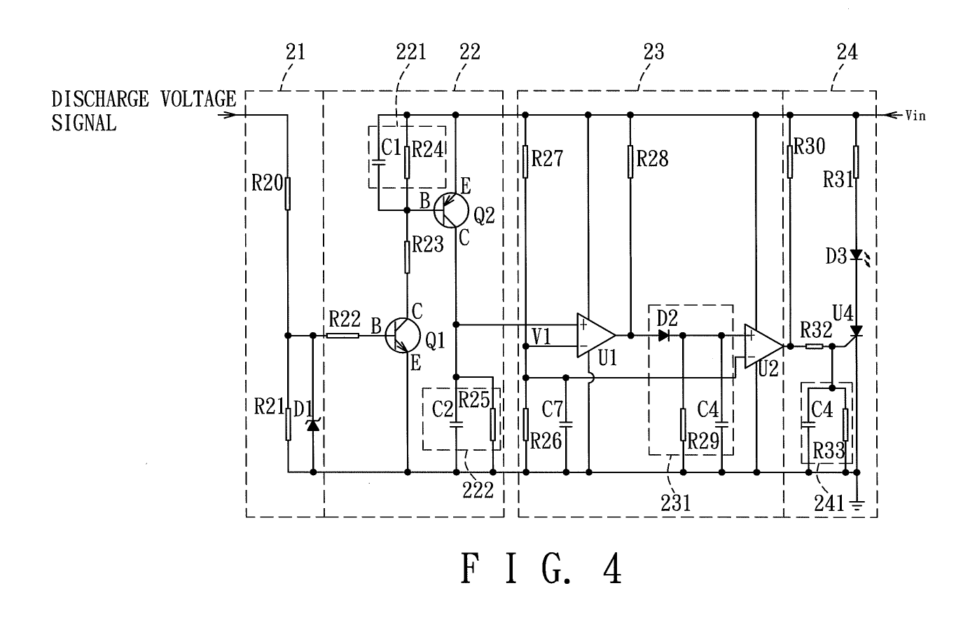

Referring to FIGS. 3 and 4, the preferred embodiment of a circuit for detecting high-voltage discharge of a gas-actuated fastener-driving gun (not shown) according to the present invention is shown to include an attenuating unit 21, a signal processing unit 22, a determining unit 23, and a warning unit 24. The gas-actuated fastener-driving device includes an ignition system that generates a discharge voltage signal corresponding to the high-voltage discharge.

The attenuating unit 21 is adapted to be coupled to the ignition system, receives the discharge voltage signal from the ignition system, and attenuates the discharge voltage signal to generate a positive pulse signal. In this embodiment, the attenuating unit 21 includes a voltage dividing circuit, which consists of first and second resistors (R20, R21) connected in series, and a regulated diode (D1) connected in parallel to the resistor (R21). The first resistor (R20) is adapted to be coupled to a discharge needle or a spark plug nut of the ignition system. The second resistor (R21) is connected electrically to ground. The regulated diode (D1) is a zener diode that has a zener anode connected electrically to ground, and a zener cathode coupled to a common node between the first and second resistors (R20, R21). The first resistor (R20) has a resistance greatly larger than that of the resistor (R21), for example, R20/R21=10000. The discharge voltage signal has positive pulse components and negative pulse components. The positive pulse components enable the regulated diode (D1) to cut off. The negative pulse components enable the regulated diode (D1) to conduct. However, when the amplitude of any one of the positive pulse components is too large, the regulated diode (D1) conducts to protect a post stage of the circuit. Thus, the positive pulse signal is a voltage across the second resistor (R21).

The signal processing unit 22 is coupled to the attenuating unit 21, and receives and processes the positive pulse signal from the attenuating unit 21 to generate a processed pulse signal with an amplified amplitude. In this embodiment, the signal processing unit 22 includes a first amplifying and filtering circuit coupled to the attenuating unit 21 for amplifying and filtering the positive pulse signal to generate a processed signal, and a second amplifying and filtering circuit coupled to the first amplifying and filtering circuit for amplifying and filtering the processed signal from the first amplifying and filtering circuit to generate the processed pulse signal.

The first amplifying and filtering circuit includes a resistor (R22), and a series connection of a first filter 221, a resistor (R23) and a first transistor (Q1). The first filter 221 consists of a capacitor (C1) and a resistor (R24) connected in parallel. The first transistor (Q1) is an npn transistor. The resistor (R22) is connected electrically between the attenuating unit 21 and a base of the first transistor (Q1). The resistor (R23) is connected electrically between the first filter 221 and a collector of the first transistor (Q1). An emitter of the first transistor (Q1) is coupled to ground.

The second amplifying and filtering circuit includes a second transistor (Q2), such as a pnp transistor, and a second filter 222 connected in series. The second transistor (Q2) is a pnp transistor, and has an emitter, a base coupled to a common node between the first filter 221 and the resistor (R23), and a collector. The second filter 222 is coupled between the collector of the second transistor (Q2) and ground, and consists of a capacitor (C2) and a resistor (R25) connected in parallel. The processed pulse signal is a voltage across the second filter 222.

The determining unit 23 is coupled to the signal processing unit 22, receives the processed pulse signal from the signal processing unit 22, determines whether the processed pulse signal is greater than a predetermined voltage (V1), and outputs a control signal upon detecting that the processed pulse signal is greater than the predetermined voltage (V1). In this embodiment, the determining unit 23 includes a first comparator (U1), a rectifying and filtering circuit 231, and a second comparator (U2). The predetermined voltage (V1) is a voltage across a resistor (R26).

The first comparator (U1) is coupled to the second amplifying and filtering circuit of the signal processing unit 22 for comparing the processed pulse signal from the second amplifying and filtering circuit of the signal processing unit 22 with the predetermined voltage (V1) to generate a first comparison output that has a high level when the processed pulse signal is greater than the predetermined voltage (V1). The first comparator (U1) has a non-inverting input end coupled to the signal processing unit 22 for receiving the processed pulse signal therefrom, an inverting input end for receiving the predetermined voltage (V1), and an output end for outputting the first comparison output.

The rectifying and filtering circuit 231 is coupled to the first comparator (U1) for rectifying and filtering the comparison output from the first comparator (U1) to generate a rectified and filtered output. The rectifying and filtering circuit 231 includes a diode (D2), and a series connection of a resistor (R29) and a capacitor (C4).

The second comparator (U2) is coupled to the rectifying and filtering circuit 231 for comparing the rectified and filtered output with the predetermined voltage (V1) to generate a second comparison output that has a high level when the rectified and filtered output is greater than the predetermined voltage (V1). The second comparator (U2) has a non-inverting input end coupled to a cathode of the diode (D2) of the rectifying and filtering circuit 231, an inverting input end for receiving the predetermined voltage (V1), and an output end for outputting the second comparison output.

When the processed pulse signal and the rectified and filtered output are greater than the predetermined voltage (V1), the second comparison output generated by the second comparator (U2) serves as the control signal.

The warning unit 24 is coupled to the determining unit 23, receives the control signal from the determining unit 23, and generates, based on the control signal, a warning output for indicating that the high-voltage discharge is abnormal. In this embodiment, the warning unit 24 includes resistors (R30, R31, R32), an LED (D3), a silicon controlled rectifier (U4), and a filter 241 consisting of a resistor (R33) and a capacitor (C4) connected in parallel. The LED (D3) is activated by the control signal to emit light that serves as the warning output. In other embodiments, the warning unit 24 can include a loudspeaker or a buzzer that is activated by the control signal to generate an audio output serving as the warning output.

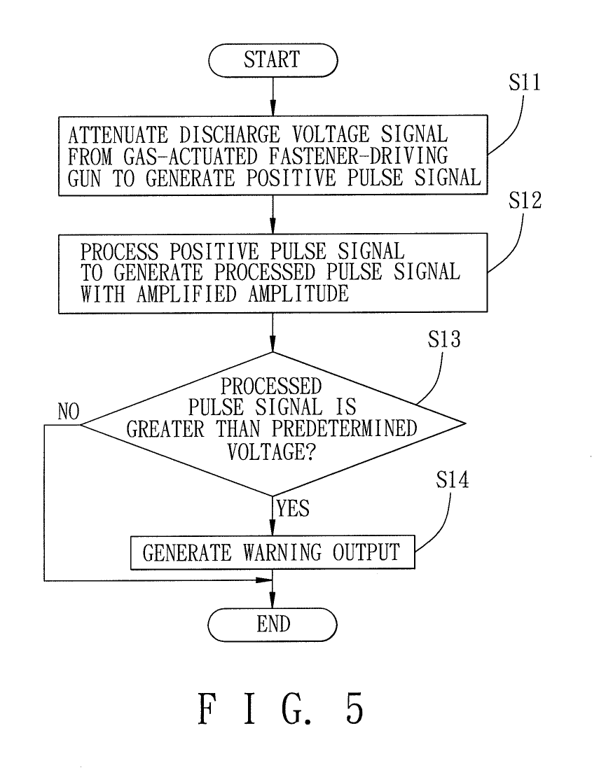

FIG. 5 illustrates a flow chart of a method of detecting high-voltage discharge of a gas-actuated fastener driving gun performed by the preferred embodiment.

In step S11, the attenuating unit 21 attenuates the discharge voltage signal from the gas-actuated fastener-driving gun to generate a positive pulse signal.

In step S12, the signal processing unit 22 processes the positive pulse signal to generate a processed pulse signal with an amplified amplitude.

In step S13, the determining unit 23 determines whether the processed pulse signal is greater than a predetermined voltage. If affirmative, the flow goes to step S14. Otherwise, the flow ends. When the processed pulse signal is greater than the predetermined voltage, the determining unit 23 outputs a control signal to the warning unit 24.

In step S14, the warning unit 24 generates a warning output based on the control signal from the determining unit 23.

In sum, the circuit and method of the present invention can detect high-voltage discharge of the gas-actuated fastener-driving gun, and appropriately generates a warning output when the high-voltage discharge is abnormal to thereby ensure proper operation of the gas-actuated fastener-driving gun.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method of detecting high-voltage discharge of a gas-actuated fastener-driving gun, comprising the steps of:
a) obtaining a discharge voltage signal generated by the gas-actuated fastener-driving gun and corresponding to the high-voltage discharge, and attenuating the discharge voltage signal to generate a positive pulse signal;
b) processing the positive pulse signal to generate a processed pulse signal with an amplified amplitude;
c) determining whether the processed pulse signal is greater than a predetermined voltage; and
d) generating a warning output for indicating that the high-voltage discharge is abnormal when the processed pulse signal is greater than the predetermined voltage.

2. The method as claimed in claim 1, wherein step b) further includes the sub-steps of:
b-1) amplifying and filtering the positive pulse signal to generate a processed signal; and
b-2) amplifying and filtering the processed signal generated in sub-step b-1) to generate the processed pulse signal.

3. The method as claimed in claim 1, wherein:
step c) further includes the sub-steps of:
c-1) comparing the processed pulse signal with the predetermined voltage to generate a first comparison output,
c-2) rectifying and filtering the first comparison output to generate a rectified and filtered output, and
c-3) comparing the rectified and filtered output with the predetermined voltage to generate a second comparison output; and
in step d), when the processed pulse signal and the rectified and filtered output are greater than the predetermined voltage, the warning output is generated.

4. A circuit for detecting high-voltage discharge of a gas-actuated fastener-driving gun, the gas-actuated fastener-driving gun including an ignition system that generates a discharge voltage signal corresponding to the high-voltage discharge, said circuit comprising:
an attenuating unit adapted to be coupled to the ignition system for receiving the discharge voltage therefrom and for attenuating the discharge voltage signal to generate a positive pulse signal;
a signal processing unit coupled to said attenuating unit, said signal processing unit receiving and processing the positive pulse signal from said attenuating unit to generate a processed pulse signal with an amplified amplitude;
a determining unit coupled to said signal processing unit, said determining unit receiving the processed pulse signal from said signal processing unit, determining whether the processed pulse signal is greater than a predetermined voltage, and outputting a control signal upon detecting that the processed pulse signal is greater than the predetermined voltage; and
a warning unit coupled to said determining unit, said warning unit receiving the control signal from said determining unit, and generating, based on the control signal, a warning output for indicating that the high-voltage discharge is abnormal.

5. The circuit as claimed in claim 4, wherein said signal processing unit includes:
a first amplifying and filtering circuit coupled to said attenuating unit for amplifying and filtering the positive pulse signal to generate a processed signal; and
a second amplifying and filtering circuit coupled to said first amplifying and filtering circuit and said determining unit for amplifying and filtering the processed signal from said first amplifying and filtering circuit to generate the processed pulse signal.

6. The circuit as claimed in claim 4, wherein:
said determining unit includes
a first comparator coupled to said signal processing unit for comparing the processed pulse signal from said signal processing unit with the predetermined voltage to generate a first comparison output,
a rectifying and filtering circuit coupled to said first comparator for rectifying and filtering the first comparison output from said first comparator to generate a rectified and filtered output, and
a second comparator coupled to said rectifying and filtering circuit and said warning unit for comparing the rectified and filtered output from said rectifying and filtering circuit with the predetermined voltage to generate a second comparison output; and
when the processed pulse signal and the rectified and filtered output are greater than the predetermined voltage, the second comparison output generated by said second comparator serving as the control signal.
